(19) United States
(12) Patent Application Publication
(10) Pub. No.: US 2026/0179828 A1
(43) Pub. Date: Jun. 25, 2026

(54) ELECTRONIC COMPONENT

(71) Applicant: TDK Corporation, Tokyo (JP)

(72) Inventor: Masamichi TANAKA, Tokyo (JP)

(73) Assignee: TDK Corporation, Tokyo (JP)

(21) Appl. No.: 19/127,425

(22) PCT Filed: Oct. 2, 2023
(86) PCT No.: PCT/JP2023/035888

§ 371 Date: May 6, 2025

(30) Foreign Application Priority Data
Nov. 10, 2022 (JP) 2022-180499

(51) Int. Cl. H01F 27/29

(52) U.S. Cl. CPC H01F 27/29

(57) ABSTRACT

To improve, in an electronic component having a structure in which conductor layers including inductors and resin layers are alternately stacked, the use efficiency of the conductor layers. An electronic component includes conductor layers and resin layers in an alternately stacking manner. The conductor layer includes a conductor pattern, and the conductor layer includes a conductor pattern. The conductor pattern includes a support part that overlaps a terminal electrode and coil parts connected to the support part without overlapping the terminal electrode. The conductor pattern includes a support part that overlaps the terminal electrode and is connected to the terminal electrode through a via formed in the resin layer and a coil part connected to the support part without overlapping the terminal electrode. The coil parts are connected to each other through the support part, and the support part is entirely covered with the resin layer.

### TECHNICAL FIELD

The present disclosure relates to an electronic Component and, more particularly, to an electronic component having an inductor.

### BACKGROUND ART

Patent Document 1 discloses an electronic component in which conductor layers including inductors and resin layers are alternately stacked, and the topmost conductor layer constitutes a terminal electrode. The resin layers each have a via at a position overlapping the terminal electrode, whereby the conductor patterns overlapping the terminal electrode are all short-circuited.

### CITATION LIST

### Patent Document

[Patent Document 1] JP 2022-094391A

### DISCLOSURE OF THE INVENTION

### Problem to be Solved by the Invention

However, when the conductor patterns overlapping the terminal electrode are all short-circuited, the use efficiency of the conductor layers is lowered.

The present disclosure describes a technology for improving, in an electronic component having a structure in which conductor layers including inductors and resin layers are alternately stacked, the use efficiency of the conductor layers.

### Means for Solving the Problem

An electronic component according to an aspect of the present disclosure includes: a first conductor layer; a first resin layer embedding therein the first conductor layer; a second conductor layer formed on the upper surface of the first resin layer or upper surface of another resin layer that covers the first resin layer; a second resin layer that covers the upper surface of the first resin layer so as to embed therein the second conductor layer; and a terminal electrode formed on the upper surface of the second resin layer. The first conductor pattern includes a first conductor pattern, the second conductor layer includes a second conductor pattern, the first conductor pattern includes a first support part that overlaps the terminal electrode at least at a part thereof and first and second coil parts connected to the first support part without overlapping the terminal electrode, the second conductor pattern includes a second support part that overlaps the terminal electrode and is connected to the terminal electrode through a via formed in the second resin layer and a third coil part connected to the second support part without overlapping the terminal electrode, the first and second coil parts are electrically connected to each other through the first support part, and the first support part is entirely covered with the first resin layer.

### Advantageous Effects of the Invention

As described above, according to the present disclosure, in an electronic component having a structure in which conductor layers including inductors and resin layers are alternately stacked, a technology for increasing the use efficiency of the conductor layers is provided.

### BRIEF DESCRIPTION OF THE DRAWINGS

FIG. 1 is a schematic perspective view illustrating the outer appearance of an electronic component 1 according to an embodiment of the technology according to the present disclosure.

FIG. 2 is a schematic exploded perspective view of the electronic component 1.

FIG. 3 is a schematic plan view illustrating the pattern shape of the conductor layer M1.

FIG. 4 is a schematic plan view illustrating the pattern shape of the conductor layer MM.

FIG. 5 is a schematic plan view illustrating the positions of vias provided in the resin layer 21.

FIG. 6 is a schematic plan view illustrating the pattern shape of the conductor layer M2.

FIG. 7 is a schematic plan view illustrating the positions of vias provided in the resin layer 22.

FIG. 8 is a schematic plan view illustrating the pattern shape of the conductor layer M3.

FIG. 9 is a schematic plan view illustrating the positions of vias provided in the resin layer 23.

FIG. 10 is a schematic plan view illustrating the pattern shape of the conductor layer M4.

FIG. 11 is a schematic partial cross-sectional view of the electronic component 1.

### MODE FOR CARRYING OUT THE INVENTION

Hereinafter, preferred embodiments of the present invention will be described in detail with reference to the accompanying drawings.

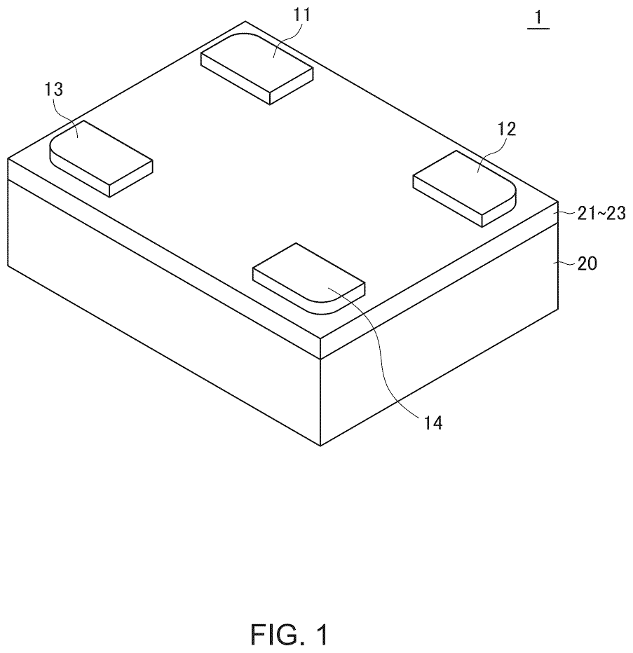

FIG. 1 is a schematic perspective view illustrating the outer appearance of an electronic component 1 according to an embodiment of the technology according to the present disclosure.

The electronic component 1 according to the present disclosure is a surface-mount LC filter and has, as illustrated in FIG. 1, a support substrate 20, a plurality of resin layers 21 to 23 stacked on the surface of the support substrate 20, and terminal electrodes 11 to 14 formed on a mounting surface. The material of the support substrate 20 is not particularly limited as long as it is chemically and thermally stable, generates less stress, and can maintain surface smoothness, and examples thereof include silicon single crystal, alumina, sapphire, aluminum nitride, MgO single crystal, SrTiO₃ single crystal, surface-oxidized silicon, glass, quartz, and ferrite.

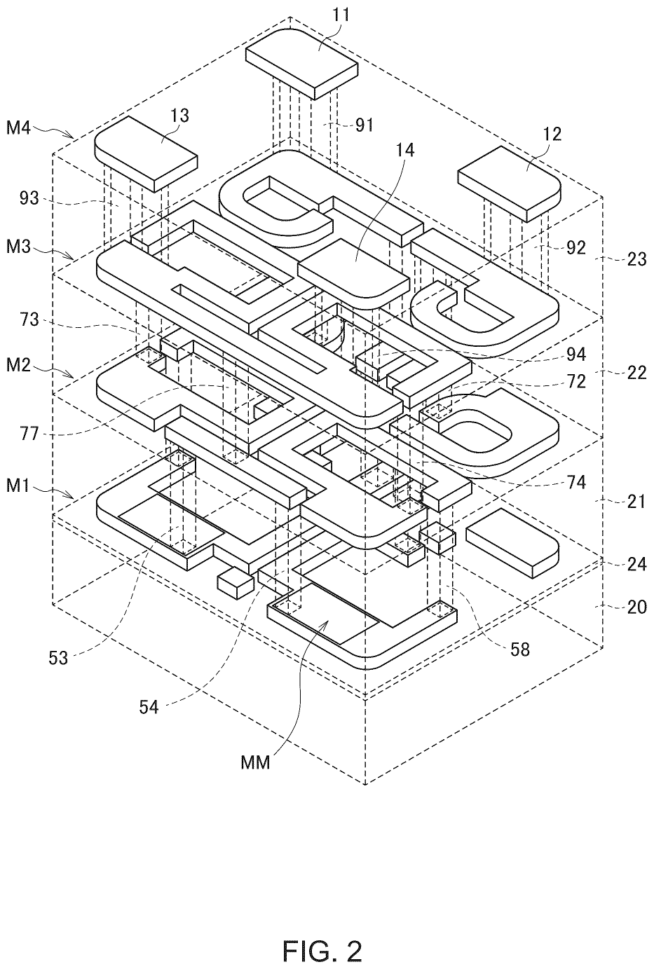

FIG. 2 is a schematic exploded perspective view of the electronic component 1.

As illustrated in FIG. 2, conductor layers M1, MM, M2, M3, and M4, which are made of Cu or the like, are provided on the support substrate 20. The conductor layer M1 is provided on a planarizing layer 24 covering the surface of the support substrate 20 and embedded in the resin layer 21. The planarizing layer 24 may be made of alumina, silicon oxide, or the like. The conductor layer M2 is provided on the upper surface of the resin layer 21 and embedded in the resin layer 22. The conductor layer M3 is provided on the upper surface of the resin layer 22 and embedded in the resin layer 23. The conductor layer M4 includes the terminal electrodes 11 to 14 provided on the upper surface of the resin layer 23. The conductor layer MM is provided on the upper surface of the conductor layer M1 through a not-shown capacitive insulating film and embedded in the resin layer 21.

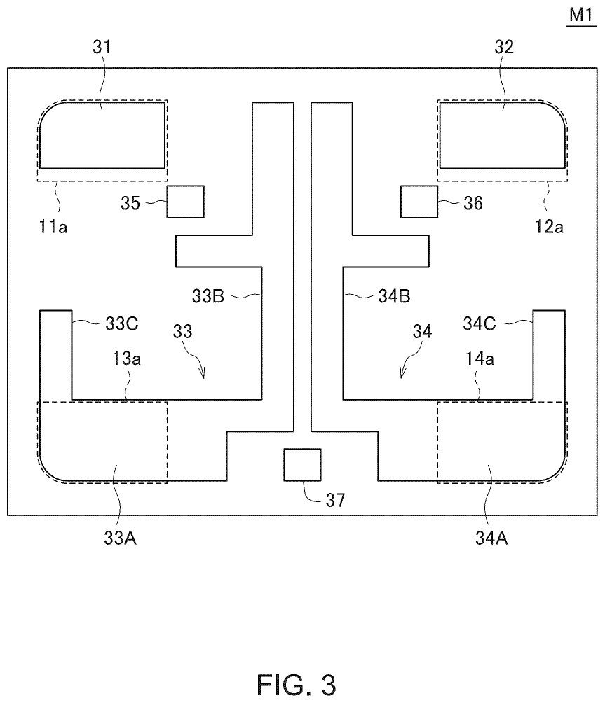

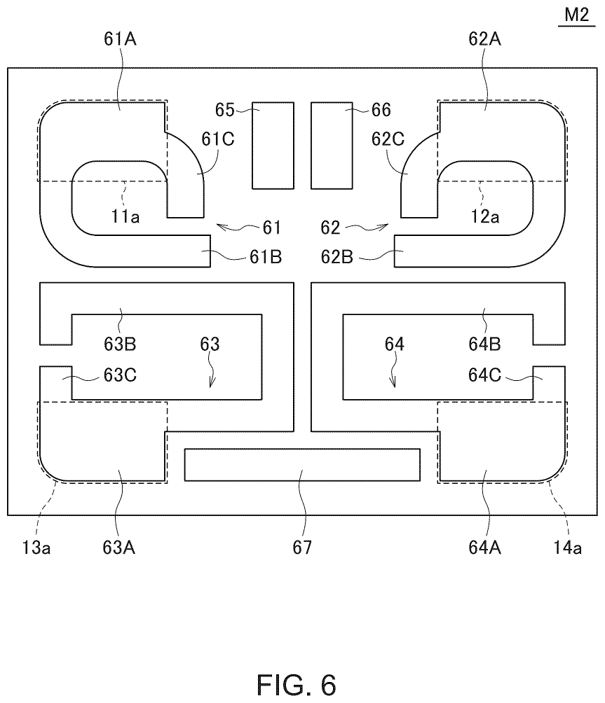

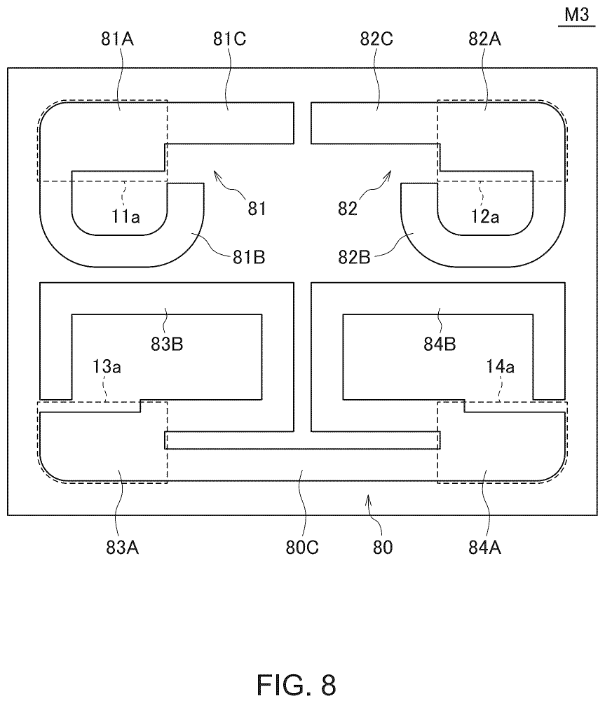

As illustrated in FIG. 3, the conductor layer M1 includes a plurality of conductor patterns 31 to 37. The conductor patterns 31, 32, 33, and 34 overlap the terminal electrodes 11, 12, 13, and 14, respectively, in a plan view. Specifically, areas 11a, 12a, 13a, and 14a denoted by dashed lines in FIG. 3 overlap the terminal electrodes 11, 12, 13, and 14, respectively, in a plan view. The same applies in FIGS. 6 and 8 to be described later.

The conductor pattern 33 includes a support part 33A overlapping the terminal electrode 13 at least at a part thereof and coil parts 33B and 33C which do not overlap the terminal electrode 13. The coil parts 33B and 33C are connected to different positions of the support part 33A and are thus connected to each other through the support part 33A. Similarly, the conductor pattern 34 includes a support part 34A overlapping the terminal electrode 14 at least at a part thereof and coil parts 34B and 34C which do not overlap the terminal electrode 14. The coil parts 34B and 34C are connected to different positions of the support part 34A and are thus connected to each other through the support part 34A. The layout and shape of the connection portion between the support part 33A and each of the coil parts 33B and 33C are not particularly limited, and it may be formed so as to overlap the terminal electrode 13 at least at a part thereof in a plan view or may be formed at a position not overlapping the terminal electrode 13. The same applies for the support part 34A.

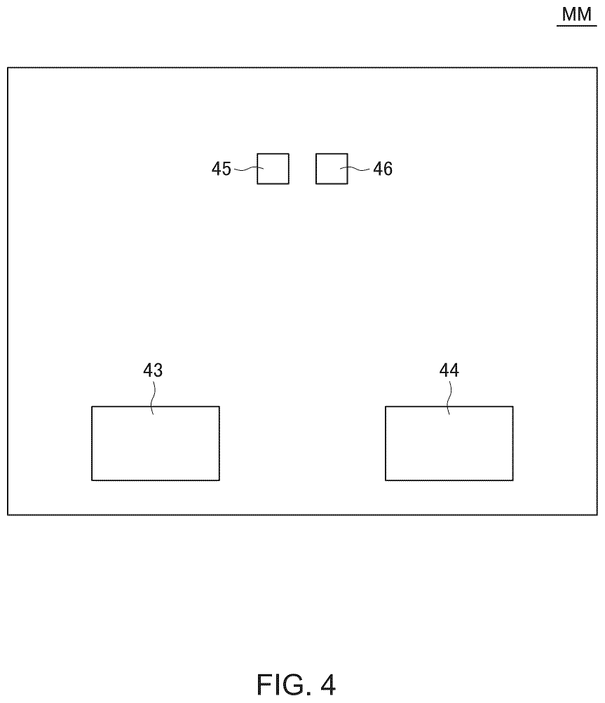

As illustrated in FIG. 4, the conductor layer MM includes a plurality of conductor patterns 43 to 46. The conductor patterns 43 and 45 are provided on the conductor pattern 33 positioned in the conductor layer M1 through the capacitive insulating film. Similarly, the conductor patterns 44 and 46 are provided on the conductor pattern 34 positioned in the conductor layer M1 through the capacitive insulating film. Thus, the conductor patterns 43 to 46 function as a capacitor upper electrode, and a part of each of the conductor patterns 33 and 34 functions as a capacitor lower electrode. The conductor pattern 43 overlaps a part of the support part 33A of the conductor pattern 33 and a part of the coil part 33B of the conductor pattern 33. Similarly, the conductor pattern 44 overlaps a part of the support part 34A of the conductor pattern 34 and a part of the coil part 34B of the conductor pattern 34. That is, the conductor pattern 43 overlaps the terminal electrode 13 at least at a part thereof in a plan view, and the conductor pattern 44 overlaps the terminal electrode 14 at least at a part thereof in a plan view.

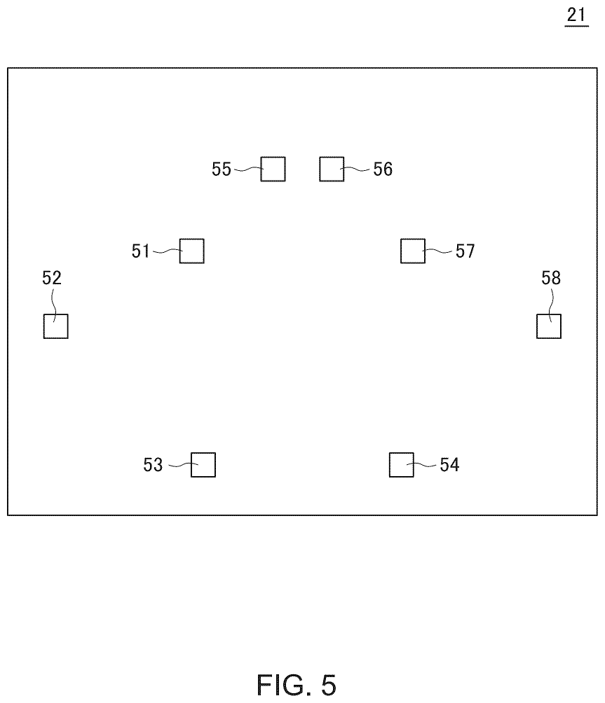

As illustrated in FIG. 5, the resin layer 21 has a plurality of vias 51 to 58 formed therein. The vias 51 and 52 expose therethrough the conductor pattern 33 positioned in the conductor layer M1, the vias 57 and 58 expose therethrough the conductor pattern 34 positioned in the conductor layer M1, and the vias 53 to 56 respectively expose therethrough the conductor patterns 43 to 46 positioned in the conductor layer MM. The vias 51 and 52 respectively expose therethrough the coil parts 33B and 33C of the conductor pattern 33, and the vias 57 and 58 respectively expose therethrough the coil parts 34B and 34C of the conductor pattern 34. Further, the via 53 is disposed at a position overlapping the coil part 33B of the conductor pattern 33, and the via 54 is disposed at a position overlapping the coil part 34B of the conductor pattern 34. The resin layer 21 has no vias at positions overlapping the support parts 31A to 34A, and the support parts 31A to 34A are each entirely covered with the resin layer 21.

As illustrated in FIG. 6, the conductor layer M2 includes a plurality of conductor patterns 61 to 67. The conductor patterns 61, 62, 63, and 64 overlap the terminal electrodes 11, 12, 13, and 14, respectively, in a plan view. The conductor pattern 61 includes a support part 61A overlapping the terminal electrode 11 at least at a part thereof and coil parts 61B and 61C which do not overlap the terminal electrode 11. The conductor pattern 62 includes a support part 62A overlapping the terminal electrode 12 at least at a part thereof and coil parts 62B and 62C which do not overlap the terminal electrode 12. The conductor pattern 63 includes a support part 63A overlapping the terminal electrode 13 at least at a part thereof and coil parts 63B and 63C which do not overlap the terminal electrode 13. The conductor pattern 64 includes a support part 64A overlapping the terminal electrode 14 at least at a part thereof and coil parts 64B and 64C which do not overlap the terminal electrode 14.

The coil parts 61B and 61C are connected to different positions of the support part 61A and are thus connected to each other through the support part 61A. The coil parts 62B and 62C are connected to different positions of the support part 62A and are thus connected to each other through the support part 62A. The coil parts 63B and 63C are connected to different positions of the support part 63A and are thus connected to each other through the support part 63A. The coil parts 64B and 64C are connected to different positions of the support part 64A and are thus connected to each other through the support part 64A. The layout and shape of the connection portion between the support part 61A and each of the coil parts 61B and 61C are not particularly limited, and it may be formed so as to overlap the terminal electrode 11 at least at a part thereof in a plan view or may be formed at a position not overlapping the terminal electrode 11. The same applies for the support parts 62A, 63A, and 64A.

The coil part 61B is connected to the coil part 33B of the conductor pattern 33 positioned in the conductor layer M1 through the via 51 formed in the resin layer 21. The coil part 62B is connected to the coil part 34B of the conductor pattern 34 positioned in the conductor layer M1 through the via 57 formed in the resin layer 21. The coil part 63B is connected to the coil part 33C of the conductor pattern 33 positioned in the conductor layer M1 through the via 52 formed in the resin layer 21. The coil part 64B is connected to the coil part 34C of the conductor pattern 34 positioned in the conductor layer M1 through the via 58 formed in the resin layer 21. The conductor patterns 65 and 66 are respectively connected to the conductor patterns 45 and 46 positioned in the conductor layer MM through the respective vias 55 and 56 formed in the resin layer 21. The conductor pattern 67 is connected to the conductor patterns 43 and 44 positioned in the conductor layer MM through the vias 53 and 54 formed in the resin layer 21.

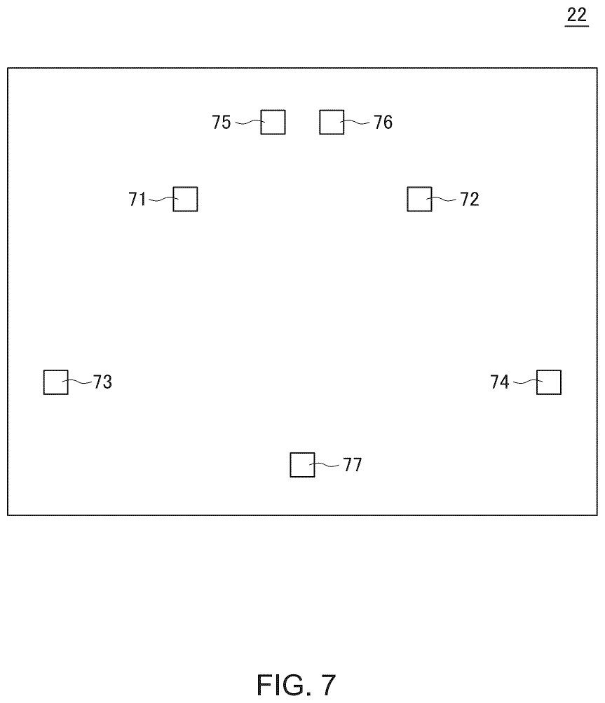

As illustrated in FIG. 7, the resin layer 22 has a plurality of vias 71 to 77 formed therein. The vias 71, 72, 73, 74, 75, 76, and 77 respectively expose therethrough the conductor patterns 61, 62, 63, 64, 65, 66, and 67 positioned in the conductor layer M2. The via 71 is disposed at a position overlapping the coil part 61C of the conductor pattern 61, the via 72 is disposed at a position overlapping the coil part 62C of the conductor pattern 62, the via 73 is disposed at a position overlapping the coil part 63C of the conductor pattern 63, and the via 74 is disposed at a position overlapping the coil part 64C of the conductor pattern 64. The resin layer 22 has no vias at positions overlapping the support parts 61A to 64A, and the support parts 61A to 64A are each entirely covered with the resin layer 22.

As illustrated in FIG. 8, the conductor layer M3 includes a plurality of conductor patterns 80 to 82. The conductor patterns 81 and 82 overlap the terminal electrodes 11 and 12, respectively, in a plan view, and the conductor pattern 83 overlaps the terminal electrodes 13 and 14 in a plan view. The conductor pattern 81 includes a support part 81A overlapping the terminal electrode 11 at least at a part thereof and coil parts 81B and 81C which do not overlap the terminal electrode 11. The conductor pattern 82 includes a support part 82A overlapping the terminal electrode 12 at least at a part thereof and coil parts 82B and 82C which do not overlap the terminal electrode 12. The conductor pattern 80 includes a support part 83A overlapping the terminal electrode 13 at least at a part thereof, a support part 84A overlapping the terminal electrode 14 at least at a part thereof, and coil parts 83B, 83C, and 80C which do not overlap the terminal electrodes 13 and 14.

The coil parts 81B and 81C are connected to different positions of the support part 81A and are thus connected to each other through the support part 81A. The coil parts 82B and 82C are connected to different positions of the support part 82A and are thus connected to each other through the support part 82A. The coil parts 83B and 80C are connected to different positions of the support part 83A and are thus connected to each other through the support part 83A. The coil parts 84B and 80C are connected to different positions of the support part 84A and are thus connected to each other through the support part 84A. The layout and shape of the connection portion between the support part 81A and each of the coil parts 81B and 81C are not particularly limited, and it may be formed so as to overlap the terminal electrode 11 at least at a part thereof in a plan view or may be formed at a position not overlapping the terminal electrode 11. The same applies for the support parts 82A, 83A, and 84A.

The coil part 81B is connected to the coil part 61C of the conductor pattern 61 positioned in the conductor layer M2 through the via 71 formed in the resin layer 22. The coil part 81C is connected to the conductor pattern 65 positioned in the conductor layer M2 through the via 75 formed in the resin layer 22. The coil part 82B is connected to the coil part 62C of the conductor pattern 62 positioned in the conductor layer M2 through the via 72 formed in the resin layer 22. The coil part 82C is connected to the conductor pattern 66 positioned in the conductor layer M2 through the via 76 formed in the resin layer 22. The coil part 83B is connected to the coil part 63C of the conductor pattern 63 positioned in the conductor layer M2 through the via 73 formed in the resin layer 22. The coil part 84B is connected to the coil part 64C of the conductor pattern 64 positioned in the conductor layer M2 through the via 74 formed in the resin layer 22. The coil part 80C is connected to the conductor pattern 67 positioned in the conductor layer M2 through the via 77 formed in the resin layer 22.

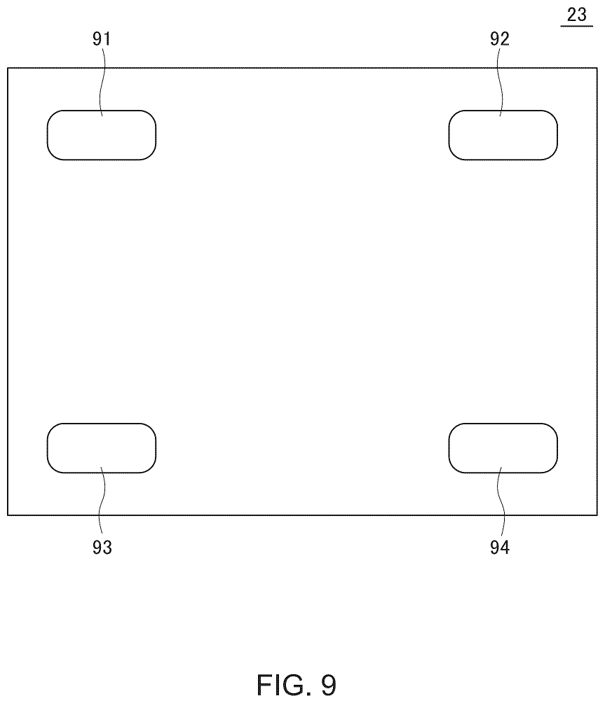

As illustrated in FIG. 9, the resin layer has a plurality of vias 91 to 94 formed therein. The vias 91, 92, 93, and 94 respectively expose therethrough the support parts 81A, 82A, 83A, and 84A positioned in the conductor layer M3. Thus, the vias 91, 92, 93, and 94 overlap the terminal electrodes 11, 12, 13, and 14, respectively.

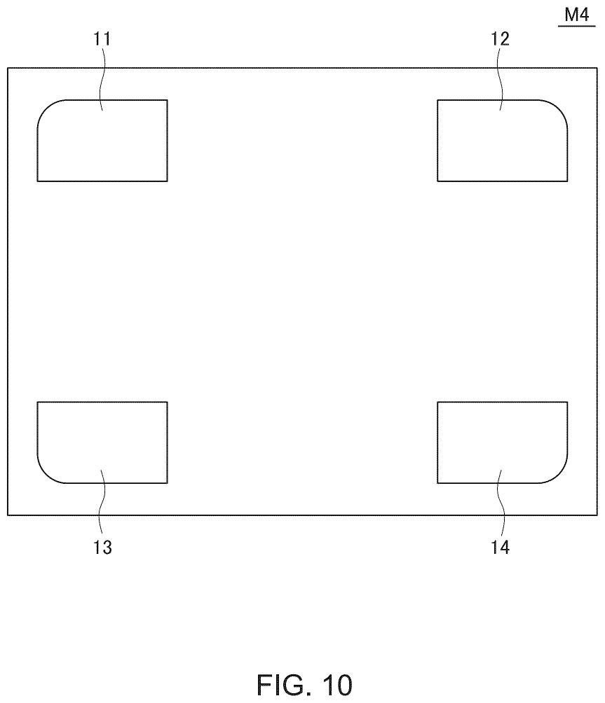

As illustrated in FIG. 10, the conductor layer M4 includes the terminal electrodes 11 to 14. The terminal electrodes 11, 12, 13, and 14 are respectively connected to the support parts 81A, 82A, 83A, and 84A positioned in the conductor layer M3 through the respective vias 91, 92, 93, and 94.

With the above configuration, an inductor constituted of the coil part 81B and conductor pattern 61 and a capacitor having the conductor pattern 45 as its upper electrode are connected in parallel between the terminal electrode 11 and the conductor pattern 33. Similarly, an inductor constituted of the coil part 82B and conductor pattern 62 and a capacitor having the conductor pattern 46 as its upper electrode are connected in parallel between the terminal electrode 12 and the conductor pattern 34. Further, an inductor constituted of the coil part 83B and conductor pattern 63 and a capacitor having the conductor pattern 43 as its upper electrode are connected in parallel between the terminal electrode 13 and the conductor pattern 33. Similarly, an inductor constituted of the coil part 84B and conductor pattern 64 and a capacitor having the conductor pattern 44 as its upper electrode are connected in parallel between the terminal electrode 14 and the conductor pattern 34. The conductor patterns 33 and 34 themselves also function as an inductor. This constitutes an LC filter having the terminal electrodes 11 and 12 as input and output terminals and terminal electrodes 13 and 14 as ground terminals.

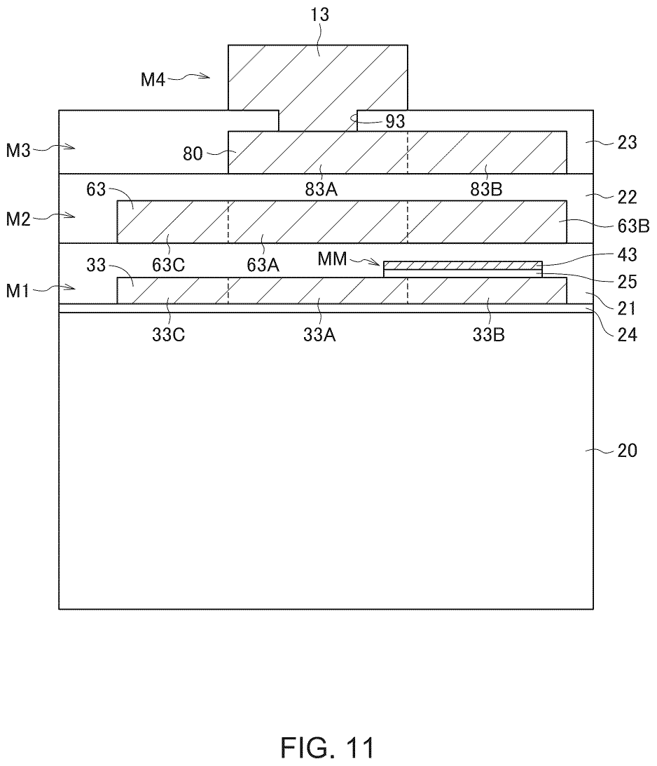

FIG. 11 is a schematic partial cross-sectional view of the electronic component 1.

As illustrated in FIG. 11, the conductor pattern 80 positioned in the conductor layer M3, the conductor pattern 63 positioned in the conductor layer M2, and the conductor pattern 33 positioned in the conductor layer Ml are provided right under the terminal electrode 13. The terminal electrode 13 is connected to the support part 83A of the conductor pattern 80 through the via 93 formed in the resin layer 23. The terminal electrode 13 is thus connected to the support part 83A of the conductor pattern 80 positioned right thereunder, so that its fixing strength is improved.

On the other hand, the resin layer 22 has no via connecting the support part 83A of the conductor pattern 80 and the support part 63A of the conductor pattern 63. Similarly, the resin layer 21 has no via connecting the support part 63A of the conductor pattern 63 and the support part 33A of the conductor pattern 33. As a result, stress to be applied to the electronic component 1 through the terminal electrode 13 is absorbed by the resin layers 21 and 22, making the lower conductor layers unlikely to be damaged. Thus, even when a part of the conductor pattern 43 as the capacitor upper electrode is disposed, through a capacitive insulating film 25, at a position overlapping the support part 33A of the conductor pattern 33, the capacitor is unlikely to be damaged, so that fluctuation, etc., of a capacitance due to damage can be prevented. Further, the area where the capacitor upper electrode can be disposed is enlarged, thus increasing design freedom.

In addition, the coil parts 63B and 63C positioned in the conductor layer M2 are connected to each other through the support part 63A, making the support part 63A function as a part of the coil pattern. Similarly, the coil parts 33B and 33C positioned in the conductor layer M1 are connected to each other through the support part 33A, making the support part 33A function as a part of the coil pattern. That is, in the conductor layers M1 and M2, a part of the coil pattern is disposed at a position overlapping the terminal electrode 13, so that it is possible to achieve a sufficient inductance while reducing chip size.

Further, the support parts 63A and 33A overlap a large part of the terminal electrode 13, allowing flatness of the base of the terminal electrode 13 to be maintained.

Although the above describes the conductor patterns right under the terminal electrode 13, the same applies to the conductor patterns positioned right under the other terminal electrodes 11, 12, and 14.

As described above, in the electronic component 1 according to the present embodiment, the conductor patterns positioned in the conductor layer M3 are respectively connected to the terminal electrodes 11 to 14 right thereabove through the vias, while in the conductor layers M1 and M2, a part of the conductor pattern that overlaps each of the terminal electrodes 11 to 14 is entirely covered with the resin layer, so that stress to be applied to the electronic component 1 through the terminal electrodes 11 to 14 is relaxed, and further, it is possible to achieve a larger inductance while reducing chip size.

While the preferred embodiment of the present disclosure has been described, the present disclosure is not limited to the above embodiment, and various modifications may be made within the scope of the present disclosure, and all such modifications are included in the present disclosure.

For example, the support parts 33A, 63A, and 83A may completely overlap or may not at least partially overlap the terminal electrode 13 in a plan view when viewed from the terminal electrode side. Similarly, the support parts 34A, 64A, and 84A may completely overlap or may not at least partially overlap the terminal electrode 14 in a plan view when viewed from the terminal electrode side, the support parts 61A and 81A may completely overlap or may not at least partially overlap the terminal electrode 11 in a plan viewwhen viewed from the terminal electrode side, and the support parts 62A and 82A may completely overlap or may not at: least partially overlap the terminal electrode 12 in a plan view when viewed from the terminal electrode side.

The technology according to the present disclosure includes the following configuration examples but not limited thereto.

An electronic component according to an aspect of the present disclosure includes: a first conductor layer; a first resin layer embedding therein the first conductor layer; a second conductor layer formed on the upper surface of the first resin layer or upper surface of another resin layer that covers the first resin layer; a second resin layer that covers the upper surface of the first resin layer so as to embed therein the second conductor layer; and a terminal electrode formed on the upper surface of the second resin layer. The first conductor pattern includes a first conductor pattern, the second conductor layer includes a second conductor pattern, the first conductor pattern includes a first support part that overlaps the terminal electrode at least at a part thereof and first and second coil parts connected to the first support part without overlapping the terminal electrode, the second conductor pattern includes a second support part that overlaps the terminal electrode and is connected to the terminal electrode through a via formed in the second resin layer and a third coil part connected to the second support part without overlapping the terminal electrode, the first and second coil parts are electrically connected to each other through the first support part, and the first support part is entirely covered with the first resin layer. With the above configuration, stress to be applied to the first conductor layer through the terminal electrode is relaxed, and use efficiency of the first conductor layer is improved.

The above electronic component may further include a third conductor layer and a third resin layer embedding therein the third conductor layer, the first conductor layer may be formed on the upper surface of the third resin layer, the third conductor layer may include a third conductor pattern, the third conductor pattern may include a third support part that overlap the terminal electrode at least at a part thereof and fourth and fifth coil parts connected to the third support part without overlapping the terminal electrode, the fourth and fifth coil parts may be electrically connected to each other through the third support part, and the third support part may be entirely covered with the third resin layer. With the above configuration, stress to be applied to the first and third conductor layers through the terminal electrode is relaxed, and the use efficiency of the first and third conductor layers is improved.

The above electronic component may further include a third conductor layer formed on the upper surface of the first resin layer and a third resin layer that covers the upper surface of the first resin layer so as to embed therein the third conductor layer, the second conductor layer may be formed on the upper surface of the third resin layer, the third conductor layer may include a third conductor pattern, the third conductor pattern may include a third support part that overlaps the terminal electrode at least at a part thereof and fourth and fifth coil parts connected to the third support part without overlapping the terminal electrode, the fourth and fifth coil parts may be electrically connected to each other through the third support part, and the third support part may be entirely covered with the third resin layer. With the above configuration, stress to be applied to the first and third conductor layers through the terminal electrode is relaxed, and the use efficiency of the first and third conductor layers is improved.

The above electronic component may further include a third conductor layer and a third resin layer embedding therein the third conductor layer, the first conductor layer may be formed on the upper surface of the third resin layer, the third conductor layer may include a third conductor pattern, the third conductor pattern may include a third support part that overlaps the terminal electrode at least at a part thereof and a lower electrode that overlaps the terminal electrode at a part thereof and does not overlap the terminal electrode at the remaining part, and the lower electrode may be covered with an upper electrode through a capacitive insulating film. With the above configuration, the area where the capacitor upper electrode can be disposed is enlarged, thus increasing design freedom.

This application claims the benefit of Japanese Patent Application No. 2022-180499, filed on Nov. 10, 2022, the entire disclosure of which is incorporated by reference herein.

### REFERENCE SIGNS LIST

1 electronic component
11-14 terminal electrode
11a-14a area overlapping with terminal electrode
20 support substrate
21-23 resin layer
24 planarizing layer
25 Capacitive insulating film
31-37 conductor pattern
33A, 34A support part
33B, 33C, 34B, 34C coil part
43-46 conductor pattern
51-58 via
61-67 conductor pattern
64A-64A support part
61B-64B, 61C-64C coil part
71-77 via
80-82 conductor pattern
81A-84A support part
81B-84B, 80C-82C coil part
91-94 via
M1, MM, M2, M3, M4 conductor layer

1. An electronic component comprising:
a first conductor layer;
a first resin layer embedding therein the first conductor layer;
a second conductor layer formed on an upper surface of the first resin layer or an upper surface of another resin layer that covers the first resin layer;
a second resin layer that covers an upper surface of the first resin layer so as to embed therein the second conductor layer; and
a terminal electrode formed on an upper surface of the second resin layer,
wherein the first conductor pattern includes a first conductor pattern,
wherein the second conductor layer includes a second conductor pattern,
wherein the first conductor pattern includes a first support part that overlaps the terminal electrode at least at a part thereof and first and second coil parts connected to the first support part without overlapping the terminal electrode,
wherein the second conductor pattern includes a second support part that overlaps the terminal electrode and is connected to the terminal electrode through a via formed in the second resin layer and a third coil part connected to the second support part without overlapping the terminal electrode,
wherein the first and second coil parts are electrically connected to each other through the first support part, and
wherein the first support part is entirely covered with the first resin layer.

2. The electronic component as claimed in claim 1, further comprising:
a third conductor layer; and
a third resin layer embedding therein the third conductor layer,
wherein the first conductor layer is formed on an upper surface of the third resin layer,
wherein the third conductor layer includes a third conductor pattern,
wherein the third conductor pattern includes a third support part that overlap the terminal electrode at least at a part thereof and fourth and fifth coil parts connected to the third support part without overlapping the terminal electrode,
wherein the fourth and fifth coil parts are electrically connected to each other through the third support part, and
wherein the third support part is entirely covered with the third resin layer.

3. The electronic component as claimed in claim 1, further comprising:
a third conductor layer formed on the upper surface of the first resin layer; and
a third resin layer that covers the upper surface of the first resin layer so as to embed therein the third conductor layer,
wherein the second conductor layer is formed on an upper surface of the third resin layer,
wherein the third conductor layer includes a third conductor pattern,
wherein the third conductor pattern includes a third support part that overlaps the terminal electrode at least at a part thereof and fourth and fifth coil parts connected to the third support part without overlapping the terminal electrode,
wherein the fourth and fifth coil parts are electrically connected to each other through the third support part, and
wherein the third support part is entirely covered with the third resin layer.

4. The electronic component as claimed in claim 1, further comprising:
a third conductor layer; and
a third resin layer embedding therein the third conductor layer,
wherein the first conductor layer is formed on an upper surface of the third resin layer,
wherein the third conductor layer includes a third conductor pattern,
wherein the third conductor pattern includes a third support part that overlaps the terminal electrode at least at a part thereof and a lower electrode that overlaps the terminal electrode at a part thereof and does not overlap the terminal electrode at a remaining part, and
wherein the lower electrode is covered with an upper electrode through a capacitive insulating film.
